(19) United States
(12) Patent Application Publication
(10) Pub. No.: US 2026/0286147 A1
(43) Pub. Date: Sep. 24, 2026

(54) A WATERBORNE COATING COMPOSITION AND ITS APPLICATIONS THEREOF

(71) Applicant: BASF COATINGS GMBH, Muenster (DE)

(72) Inventors: Shu Zhen LIU, Shanghai (CN); Haruhiko SANJO, Kanagawa (JP); Lie SHI, Shanghai (CN); Ya Tong GAO, Shanghai (CN); Kyohei HOMMA, Kanagawa (JP); Mizuki YAMADA, Tokyo (JP); Shigeyuki MIZUNO, Kanagawa (JP); Bei Bei KE, Shanghai (CN)

(21) Appl. No.: 19/168,539

(22) PCT Filed: Mar. 28, 2024
(86) PCT No.: PCT/EP2024/058411

§ 371 Date: Sep. 24, 2025

(30) Foreign Application Priority Data
Apr. 10, 2023 (WO) PCT/CN2023/087330

(51) Int. Cl. C09D 5/36; B05D 3/02; B05D 5/06; B05D 7/00; C08G 18/32; C08K 3/34; C08K 7/02; C09D 5/02; C09D 7/20; C09D 7/40; C09D 7/44; C09D 175/04

(52) U.S. Cl. CPC C09D 5/36; B05D 3/02; B05D 5/068; B05D 7/574; C08G 18/3256; C08K 3/34; C08K 7/02; C09D 5/028; C09D 7/20; C09D 7/44; C09D 7/70; C09D 175/04; B05D 2202/10; B05D 2400/00; B05D 2401/20; B05D 2420/03; B05D 2425/02; B05D 2503/00; B05D 2520/00; C08K 2201/005

(57) ABSTRACT

Disclosed herein is a waterborne coating composition comprising: a) a water-soluble or water-dispersible binder; b) a cellulose nanofiber; c) a cosolvent; and d) an effect pigment. Further disclosed herein is a wet-on-wet method of producing multilayer coating films and the multilayer coating films obtained according to the method. Also disclosed herein is a method of using the waterborne coating composition for the production of the pigmented aqueous coating material.

### TECHNICAL FIELD

The present disclosure relates to a waterborne coating composition, a coating film, a coated article, and a method for forming a multilayer coating film and more.

### BACKGROUND

In recent years, a coating film with a sparkle, pearlescent, and/or metallic appearance has been known and widely used in the fields of automobiles and the like. Such appearances can often be achieved with the use of one or more effect pigments. The term “effect pigment” refers to inorganic and/or organic pigments used in a curable coating composition to produce an appearance or effect in the cured coating composition. The quality of the appearance achieved with the use of one or more effect pigments is critically dependent on the dispersing of the pigment particles in the coating material, the size and shape of the pigment particles, rheological properties of the coating material, application of the coating material, and especially the orientation of the pigment particles in the coating layer.

Basecoat compositions could be either water or organic solvent-borne. Compared to waterborne basecoat, organic solvent-borne basecoat has the advantage in appearance. The orientation of pigments can usually be improved by increasing the amount of volatile organic solvents. However, the use of such solvents also increases the volatile organic content (VOC) of the coating composition. Because of the adverse impact VOC has on the environment, many government regulations impose limitations on the amount of solvent that can be used. With the VOC level decrease, many paint properties are becoming inferior to original high VOC version, the most typical disadvantage caused by lower solvent content is effect pigment orientation property in waterborne basecoat is getting worse.

The current color trend for OEM (Original Equipment Manufacturer) paint is visually “liquid like”. To achieve this effect, a coating film needs to have ultra-high trigger properties. This means that higher requirements are put forward for the control of effect pigment orientation. The effect pigments within the basecoat must exhibit a substantially parallel orientation to an underlying substrate.

It would thus be desirable to utilize coating composition components that provide good pigment orientation to the coating composition without the need for large amounts of solvent.

### SUMMARY OF THE DISCLOSURE

In one aspect, the present disclosure provides a waterborne coating composition comprising:
a) a water-soluble or water-dispersible binder;

b) a cellulose nanofiber;

c) a cosolvent of the formula (I)

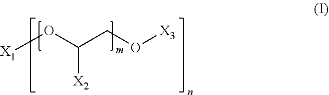

wherein
the combination of X₁ and n is (X₁, n)=(H, 1) or (CH₂—CH—CH₂, 3),
X₂ and X₃ are independently selected from hydrogen and alkyl having 1 to 8 carbon atoms, and m is an integer of 1 to 30; and
d) an effect pigment;
wherein
the waterborne coating composition has a volatile organic content of less than or equal to 420 g/l without water;
a multilayer coating film comprising a basecoat layer obtained by application of the waterborne coating composition and a clearcoat layer on the basecoat layer has a brightness index of greater than or equal to 0.20, wherein the brightness index=(L*_{15°}−L*_{25°})/L*_{15°}, L*_{15°} and L*_{25°} respectively represent lightness values measured at viewing angles of 15° and 25° according to the L*a*b* color system (CIE lab).

The afore-mentioned waterborne coating composition is hereinafter also referred to as “waterborne coating composition of the disclosure”, “waterborne coating composition according to the disclosure”, “the coating composition of the disclosure”, or “the coating composition according to the disclosure”.

In another aspect, the present disclosure provides a coating film obtained from the waterborne coating composition of this disclosure having a dry film thickness of greater than 5 μm.

In another aspect, the present disclosure provides a coated article comprising a cured coating film on an object, the cured coating film being obtained by curing the waterborne coating composition of this disclosure.

In another aspect, the present disclosure provides a method for producing a multilayer coating film, comprising:
(1) optionally producing a cured first coating layer on the substrate by application of a coating material to the substrate and subsequent curing of the composition;
(2) producing one or more basecoat layers on the coating layer obtained in step (1) by application of one or more identical or different aqueous basecoat materials;
(3) producing one or more clearcoat layers on the one or the topmost basecoat layer by application of one or more identical or different clearcoat materials;
and (4) jointly curing the one or more basecoat layers and the one or more clearcoat layers;
wherein
at least one of the basecoat materials is the waterborne coating composition of this disclosure.

The afore-mentioned method for producing a multilayer coating film is hereinafter also referred to as “method of the disclosure” or “method according to the disclosure”.

In another aspect, the present disclosure provides a multilayer coating film obtainable by the above method of this disclosure.

In a further aspect, the present disclosure provides the use of the waterborne coating composition of this disclosure for the production of the pigmented aqueous coating materials.

It has been surprisingly found that high effect pigment orientation has been realized based on the waterborne coating composition with low VOCs according to the present disclosure. The waterborne coating composition of the disclosure has a higher solid content and therefore a higher transfer efficiency and good environmental profile. The waterborne coating composition of the disclosure has the advantages of simple preparation, low cost, effient transfer and wide application, for example, different types of effect pigments can be used in this disclosure, especially non-vapor deposited metal pigments. In some preferred embodiments an automotive painting with a visually “liquid like” appearance may be obtained using the waterborne coating composition of the disclosure. In other preferred embodiments, the disclosure can be applied to a wet-to wet coating process and the obtained multilayer coating film has a balanced and good performances in appearance and mechanical properties like hardness.

Those skilled in the art will realize that the above recognized advantages and other advantages described herein are merely illustrative and are not meant to be a complete rendering of all of the advantages of the various embodiments.

### DETAILED DESCRIPTION OF THE DISCLOSURE

The present disclosure now will be described more fully hereinafter, in which some, but not all embodiments of the disclosure are shown. Indeed, this disclosure can be embodied in many different forms and should not be construed as limited to the embodiments set forth herein; rather, these embodiments are provided so that this disclosure will satisfy applicable legal requirements.

In the context of the present disclosure, expressions “a”, “an”, “the”, when used to define a term, include both the plural and singular forms of the term.

In the context of the present disclosure, the terms “comprise”, “comprising”, etc. are used interchangeably with “contain”, “containing”, etc. and are to be interpreted in a non-limiting, open manner. That is, e.g., further components or elements may be present. The expressions “consists of” or “consists essentially of” or cognates, if used, may be embraced within “comprises” or cognates.

In the context of the present disclosure, for convenience, “resin” is used in this disclosure to encompass resin, oligomer, and polymer. “Binder” refers to the film-forming components of the coating composition. Thus, resins and other film-formers are part of the binder, but crosslinkers, solvents, pigments, additives like antioxidants, light stabilizer (such as hindered amine light stabilizer, HALS), UV absorbers, and the like are not part of the binder.

In the context of the present disclosure, “CIE lab”, also referred to as L*a*b*, is a color space defined by the International Commission on Illumination (abbreviated CIE) in 1976. It expresses color as three values: L* for perceptual lightness; a* and b* for the four unique colors of human vision: red, green, blue and yellow.

In the content of the present disclosure, “free organic solvents” refers to the organic solvent existing in the composition in the form of free state, specifically refers to organic solvents added in addition to the composition, excluding solvents contained or inside in resins or additives themselves. So does “free water” mean.

In the context of the present disclosure, “number average molecular weight” is determined by gel permeation chromatography of a sample dissolved in tetrahydrofuran using polystyrene or poly(methyl methacrylate) standards.

In the context of the present disclosure, “solid content” refers to a proportion of non-volatile material contained in a coating, paint or other suspension that is the material left after the volatile solvent and water has vaporized.

In the context of the present disclosure, “acrylic resin” includes acrylic resin and methacrylic resin, and “acrylic monomer” includes acrylic monomer and methacrylic monomer. “(meth)acrylate” means acrylate and methacrylate, “(meth)acrylic” means acrylic acid and methacrylic acid, “(meth)acrylamide” means acrylamide and meth acrylamide.

Reference throughout the specification to “an embodiment or example,” “one embodiment or example,” “another embodiment or example,” “other embodiments or examples,” “some embodiments or examples,” and so forth, means that a particular element (e.g., feature, structure, property, and/or characteristic) described in connection with the embodiment/example is included in at least an embodiment/example described herein, and may or may not be present in other embodiments/examples. In addition, it is to be understood that the described element(s) can be combined in any suitable manner in the various embodiments or examples unless the context clearly dictates otherwise.

### Coating Composition

The present disclosure provides a waterborne coating composition comprising
a) a water-soluble or water-dispersible binder;
b) a cellulose nanofiber;
c) a cosolvent of the formula (I)

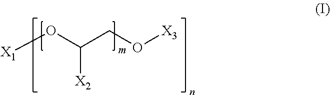

wherein
the combination of X₁ and n is (X₁, n)=(H, 1) or (CH₂—CH—CH₂, 3),
X₂ and X₃ are independently selected from hydrogen and alkyl having 1 to 8 carbon atoms, and
m is an integer of 1 to 30; and
d) an effect pigment.

In this disclosure, each component of the waterborne coating composition may be used in one alone or in a combination of two or more thereof in a desired ratio.

The term “waterborne coating composition” refers to coating compositions wherein greater than 50% by weight of the volatile content of the coating composition is water.

The waterborne coating composition of the disclosure is more environment-friendly and has a low volatile organic content, which is less than or equal to 420 g/L without water (or water out), preferably less than or equal to 410 g/L (water out), more particularly less than or equal to 407 g/L (water out). In some preferred embodiments, the waterborne coating composition has a volatile organic content of less than or equal to 150 g/L (water in), preferably of less than or equal to 145 g/L (water in), more particularly of less than or equal to 140 g/L (water in).

The waterborne coating composition of the disclosure has a relatively high solid content. It is therefore preferred if the composition has a solid content of greater than 15 wt. %, preferably of 17 to 60 wt. %, more particularly of 18 to 50 wt. %, based in each case on the total weight of the coating material and measured according to DIN EN ISO 3251 (June 2008) as detailed in the 25 Examples section of this specification. In light of the high solid content, the waterborne coating compositions of the disclosure have a high transfer efficiency, good environmental profile without any adverse effect, though, on their storage stability. The disclosed composition has a high solid content while achieving a good effect pigment orientation, which is not expected by those skilled in the art.

In some preferred embodiments, the waterborne coating composition has a thixotropy value (Ti value) of less than or equal to 40, preferably of less than or equal to 36, more particularly of less than or equal to 33, wherein the Ti value=η(A)/η(B), η(A) is viscosity under a shearing rate of 1000 s⁻¹ and η(B) is viscosity under a shearing rate of 1 s⁻¹, measured using a rotational 35 viscometer at 23° C. Low viscosity dependence improves the fluidity of the waterborne coating composition, which in turn contributes to high effect pigment orientation.

The waterborne coating composition of the disclosure preferably has a pH in the range of 4 to 10, more preferred in the range of 5 to 10, even more preferred in the range of 7 to 10, more particularly of 7 to 9, measured in each case at 23° C.

### Water-Soluble or Water-Dispersible Binder

The term “water-soluble or water-dispersible” is well known in the art. The binder may be any that is suitable for film-forming in waterborne coating compositions. Preferably, the water-soluble or water-dispersible binder comprises at least one selected from following resins: acrylic resin, polyurethane resin, acrylic-urethane resin, polyester resin, polyether resin, alkyd resin, polycarbonate resin and epoxy resin. These resins may be used alone or in combination of two or more. Such resins or polymers are well-known in the art.

Herein, there is no particular restriction to the acrylic resins, which may be any water soluble or dispersible acrylic resins. Such resins can be prepared from monomers such as methyl acrylate, methyl methacrylate, acrylic acid, methacrylic acid, ethyl acrylate, ethyl methacrylate, propyl acrylate, propyl methacrylate, isopropyl acrylate, isopropyl methacrylate, butyl acrylate, butyl methacrylate, isobutyl acrylate, isobutyl methacrylate, tert-butyl acrylate, tert-butyl methacrylate, amyl acrylate, amyl methacrylate, hexyl acrylate, hexyl methacrylate, ethylhexyl acrylate, ethylhexyl methacrylate, 3,3,5-trimethylhexyl acrylate, 3,3,5-trimethylhexyl methacrylate, stearyl acrylate, stearyl methacrylate, lauryl acrylate or lauryl methacrylate, cycloalkyl acrylates and/or cycloalkyl methacrylates, such as cyclopentyl acrylate, cyclopentyl methacrylate, isobornyl acrylate, isobornyl methacrylate, cyclohexyl acrylate and cyclohexyl methacrylate and vinylaromatic hydrocarbons, such as vinyltoluene, alpha-methylstyrene and styrene, as well as amides or nitriles of acrylic or methacrylic acid, vinyl esters and vinyl ethers. Any crosslinkable functional group, e.g., hydroxyl, amine, glycidyl, carbamate, and so on can be incorporated into the ester portion of the acrylic monomer. Nonlimiting examples of hydroxy-functional acrylic monomers that can be used to form such polymers include hydroxyethyl acrylate, hydroxybutyl acrylate, hydroxybutyl methacrylate, hydroxypropyl acrylate. Amino-functional acrylic monomers would include t-butylaminoethyl methacrylate and t-butylamino-ethylacrylate. Glycidyl groups may be incorporated by copolymerizing glycidyl methacrylate or allyl glycidyl ether, for example. Other acrylic monomers having crosslinkable functional groups in the ester portion of the monomer are also within the skill of the art. Modified acrylic resins may also be used such as polyester-modified acrylics. Polyester-modified acrylics modified with e-caprolactone are described in U.S. Pat. No. 4,546,046 of Etzell et al.

In one embodiment of the disclosure, suitable acrylic resins are typically hydroxy-containing acrylic resins. The hydroxy-containing acrylic resins may be copolymerization product of a hydroxy-containing polymerizable unsaturated monomer and at least one unsaturated monomers copolymerizable with the hydroxy-containing polymerizable unsaturated monomer, for example in form of an aqueous dispersion. The hydroxy-containing polymerizable unsaturated monomer are known in the art, for example, monoesters of (meth)acrylic acid and a dihydric alcohol having 2 to 8 carbon atoms, such as 2-hydroxyethyl (meth)acrylate, 2-hydroxypropyl (meth)acrylate, 3-hydroxypropyl (meth)acrylate, and 4-hydroxybutyl (meth)acrylate; ε-caprolactone-modified compounds of the monoesters of (meth)acrylic acid and a dihydric alcohol having 2 to 8 carbon atoms; N-hydroxymethyl (meth)acrylamide; allyl alcohol; and (meth)acrylates having hydroxy-terminated polyoxyethylene chains, as described in U.S. Pat. No. 9,701,866B2. There is no particular restriction to the at least one unsaturated monomers copolymerizable with the hydroxy-containing polymerizable unsaturated monomer, which may be suitably selected according to the properties required of the hydroxy-containing acrylic resin. Examples of the unsaturated monomers copolymerizable with the hydroxy-containing polymerizable unsaturated monomer may include, but are not limited to, those as described in U.S. Pat. No. 9,701,866B2, i.e.

In another embodiment of the disclosure, the hydroxy-containing acrylic resins have a number average molecular weight of 500 to 20,000 and more preferably of 1500 to 10,000. Further, the hydroxy-containing acrylic resins preferably have an acid value of 1 to 200 mg KOH/g, more preferably 2 to 180 mg KOH/g. The hydroxy-containing acrylic resins useful for the waterborne coating composition according to present disclosure may be those prepared by any methods known in the art or may be commercially available. Examples of commercially available hydroxy-containing acrylic resins useful for the waterborne coating composition according to present disclosure include Setaqua® 6160, Viacryl® VSC 6800W/47WA and Vlacryl® VSC 6276W/44WA, from Allnex Resins Germany GMBH and NeoCryl XK-110 from DSM.

Suitable polyurethane resins are typically addition polymerization products of an organic compound having at least two reactive hydrogen functionalities and a polyisocyanate, for example in form of an aqueous dispersion. The polyurethane resins may have been modified for hydrophilic stabilization or for increasing the dispersibility in aqueous medium by introducing cationic or anionic modifying groups, or potentially ionic groups which can be converted into cationic, anionic groups. Such polyurethane resins are often called ionically hydrophilically stabilized polyurethane resins in the art. Alternatively, the polyurethane resins may have been modified by introducing nonionic hydrophilically modifying groups. Suitable cationic, anionic and/or nonionic modification of polyurethane resins are known for example from WO2013/128011A1.

In one embodiment of the disclosure, the polyurethane resin preferably contained preferably has a number average molecular weight of from 200 to 30,000 g/mol, preferably from 2,000 to 20,000 g/mol. It also has, for example, a hydroxyl number of 5 to 250 mg KOH/g, but especially from 20 to 150 mg KOH/g. The acid number of the polyurethane resin is preferably from 5 to 200 mg KOH/g, in particular from 10 to 40 mg KOH/g. The hydroxyl number is determined according to DIN/ISO 4629, the acid number according to DIN 53402.

The polyurethane resins useful for the waterborne coating composition according to present disclosure may be those prepared by any methods known in the art or may be commercially available. Examples of commercially available polyurethane resins useful for the waterborne coating composition according to present disclosure include DAOTAN® TW 1237/32WA from Allnex Resins Germany GMBH, and Basonol® PU 1035W from BASF (China) Company Ltd.

Polyester resin can also be used as a binder resin in the coating composition. Polyester resins may be formulated as acid-functional or hydroxyl-functional resins. Polyester resins are preferably hydroxy-functional and especially preferably possess an OH number in the range from 20 to 300 mg KOH/g, more preferably from 40 to 150 mg KOH/g. Used more preferably are at least two mutually different hydroxy-functional polyesters as further binder. In one embodiment of the disclosure, the polyester resin have a number average molecular weight of 400 to 5,000 and more preferably of 500 to 4,000. The polyester resins useful for the waterborne coating composition according to present disclosure may be those prepared by any methods known in the art or may be commercially available. Such as Uralac SN800 from DSM, WATERSOL ZHW-1346 from Eternal.

In one embodiment of the disclosure, arylic urethane resin, polyether resin, alkyd resin, polycarbonate resin or epoxy resin can also be used as a binder resin in the coating composition. Arylic urethane resin can obtain the synergistic effects of acryl and urethane, improve compatibility when applied to acrylic resin-based coating compositions, and reduce the cost of urethane resin particles. Those resins may be those prepared by any methods known in the art or may be commercially available.

In one embodiment of the disclosure, for better pigment orientation, the binder comprises acrylic resin, polyurethane resin and polyester resin. Further, the mass of the three resins accounts for more than 70 wt. % of the mass of the water-soluble or water-dispersible binder, preferably at least 80 wt. %, more preferably the mass fraction is 100 wt. %.

The total amount of all polymeric binders based on the total weight of the waterborne coating composition of the disclosure, is preferably from 9 to 60 wt. %, more preferred from 10 to 50 wt. % and most preferred from 15 to 30 wt. %.

### Cellulose Nanofiber

The term “cellulose nanofiber” may also be referred to as “cellulose nanofibril,” “fibrillated cellulose,” or “nanocellulose crystal” in the literature; all of which are fiber shaped. The term is “cellulose nanofiber” is a generic term encompassing natural as well as functionalized cellulose nanofibers, such as carboxylated or sulfated or otherwise modified and/or surface functionalized cellulose nanofibers. However, the backbone carrying such groups is always cellulose. Of course, cellulose derivatives which are not fiber-shaped do not fall under the term “cellulose nanofiber”. Particularly, hydroxyalkyl celluloses, which are, e.g., dissolved in aqueous media, are not encompassed by the term “cellulose nanofiber” as used herein. The term “cellulose nanofiber” can be referred to as CNF in this disclosure.

The inventors of the disclosure accidentally discovered that the composition of the disclosure greatly facilitates the orientation of the effect pigment by combining cellulose nanofibers with a specific cosolvent. It should be noted that although the addition of cellulose nanofibers to the composition has been proposed in the literature to improve the dispersity of the pigment, working together with specific solvent to enhance flake orientation performance is the first time reported.

The cellulose nanofibers for use may be those obtained by defibrating a cellulose material and stabilizing it in water. The cellulose material as used here refers to cellulose-main materials in various forms. Specific examples include pulp (e.g., grass plant-derived pulp, such as wood pulp, jute, Manila hemp, and kenaf); natural cellulose, such as cellulose produced by microorganisms; regenerated cellulose obtained by dissolving cellulose in a copper ammonia solution, a solvent of a morpholine derivative, or the like, and subjecting the dissolved cellulose to spinning; and fine cellulose obtained by subjecting the cellulose material to mechanical treatment, such as hydrolysis, alkali hydrolysis, enzymatic decomposition, blasting treatment, vibration ball milling, and the like, to depolymerize the cellulose.

The method for defibrating the cellulose material is not particularly limited, as long as the cellulose material remains in a fibrous form. Examples of the method include mechanical defibration treatment using a homogenizer, a grinder, and the like; chemical treatment using an oxidation catalyst and the like; and biological treatment using microorganisms and the like.

For the cellulose nanofibers, anionically modified cellulose nanofibers may be used and are preferably used. Examples of anionically modified cellulose nanofibers include carboxylated cellulose nanofibers, carboxymethylated cellulose nanofibers, sulfated cellulose nanofibers and the like. The anionically modified cellulose nanofibers can be obtained, for example, by incorporating functional groups such as carboxyl groups and carboxymethyl groups into a cellulose material by a known method, washing the obtained modified cellulose to prepare a dispersion of the modified cellulose, and defibrating this dispersion. The defibration method is not particularly limited. The amount of carboxyl group in the oxidized cellylose is preferably set to be 0.2 mmol/g or more based on the solids content mass of the oxidized cellulose. The amount of carboxyl group can be adjusted by controlling the oxidation reaction time, controlling the oxidation reaction temperature, controlling the pH during the oxidation reaction, or controlling the amount of N-oxyl compound, bromide, iodide, or oxidant. The carboxymethyl substitution degree per glucose unit in the modified cellulose obtained by introducing a carboxymethyl group into the above cellulose raw material is preferably 0.02 to 0.50.

In one embodiment of the disclosure, the cellulose nanofibers preferably have a numerical average fiber diameter within the range of preferably 2 to 800 nm, more preferably 2 to 500 nm, even more preferably 2 to 250 nm, and most preferably preferably 2 to 150 nm.

In another embodiment of the disclosure, the cellulose nanofibers preferably have a numerical average fiber length within the range of preferably 0.04 to 20 μm, more preferably 0.04 to 15 μm, even more preferably 0.04 to 10 μm. The aspect ratio determined by dividing the numerical average fiber length by the numerical average fiber diameter is preferably within the range of preferably 20 to 10000, more preferably 20 to 5000, and even more preferably 20 to 1000. The numerical average values of fiber length, diameter and aspect ratio of the cellulose nanofibers can be determined by SEM or AFM.

Examples of commercial products of the cellulose nanofibers include Rheocrysta (registered trademark, produced by Dai-Ichi Kogyo Seiyaku Co., Ltd.); Cebina Fine (length 0.5 to 10 μm, diameter 15 to 100 nm), Celluforce NCV100 (length 44 to 108 nm, diameter 2.3 to 4.5 nm). The above mentioned powder is dispersed in deionized water and the dispersion has a solid content of 1.0 to 6.0 wt. %, preferably of 1.0 to 3.0 wt. %.

In one embodiment of the disclosure, in order to obtain better synergistic effects of the cellulose nanofiber and the cosovent, an effective content of the cellulose nanofiber based on the total weight of the waterborne coating composition, is preferably in the range from 0.35 wt. % to 0.80 wt. %, more preferred from 0.40 to 0.75 wt. % and most preferred from 0.55 to 0.70 wt. %. The effective content is the mass amount of cellulose nanofibers contained in the cellulose nanofiber solution or dispersion. If the effective content of the cellulose nanofiber is too low, it may be difficult to improve the rheological properties of the composition, and then a multilayer film with good color performance cannot be obtained; there is an upper limit of cellulose nanofiber in the waterborne coating composition, no more orientation improvement was obtained with higher content while the cost will getting higher.

### Cosolvent

The term “cosolvent” refers to a solvent or diluent (eg, acid or organic solvent) other than water is present in the aqueous composition. In the disclosure, the cosolvent is added in addition to the composition and the cosolvent has the following general formula (I):

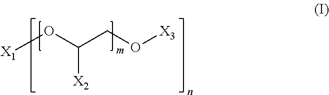

wherein
the combination of X₁ and n is (X₁, n)=(H, 1) or (CH₂—CH—CH₂, 3),
X₂ and X₃ are independently selected from hydrogen and alkyl having 1 to 8 carbon atoms (also represented as “C₁₋₈ alkyl”), and m is an integer of 1 to 30. The cosolvent may be used alone or in combination of two or more.

The term “alkyl” or “alkyl group” as used herein, means a straight-chain (i.e., unbranched) or branched, substituted or unsubstituted hydrocarbon chain that is completely saturated. In some embodiments, alkyl groups contain 1-6 carbon atoms, and in yet other embodiments, alkyl groups contain 1-4 carbon atoms. Examples of alkyl groups include methyl, ethyl, propyl, butyl, isopropyl, isobutyl, sec-butyl, tert-butyl, n-hexyl, n-heptyl and n-octyl.

In some embodiments of the disclosure, m is an integer of 1 to 25, more preferably 1 to 20, and particularly preferably 1 to 15.

In some embodiments of the disclosure, the cosolvent is diol ether compound. Preferably, the cosolvent is lipophilic and has a hydrophilic-lipophilic balance value (HLB value) of at least 9. More preferably, the cosolvent has a boiling point of at least 140° C. and/or has a vapor pressure of 500 Pa or lower.

In one embodiment of the disclosure, X₁=H, n=1, X₂ and X₃ are independently selected from hydrogen and alkyl having 1 to 8 carbon atoms, and m is an integer of 1 to 30. Preferably, X₂ and X₃ are independently selected from hydrogen and alkyl having 1 to 6 carbon atoms, and/or m is an integer of 1 to 20. More preferably, X₂ and X₃ are independently selected from hydrogen and alkyl having 1 to 5 carbon atoms, and/or m is an integer of 1 to 10. Preferred examples of the cosolvent are butyl glycol, butyldiglycol and/or ethylene glycol. The evaporation rate of small molecular cosolvents during film drying is relatively faster, which is conducive to obtaining a dry film with higher hardness.

In another embodiment of the disclosure, X₁=CH₂—CH—CH₂, n=3, X₂ and X₃ are independently selected from hydrogen and alkyl having 1 to 8 carbon atoms, and m is an integer of 1 to 30. And in this embodiment, the cosolvent has the following structure:

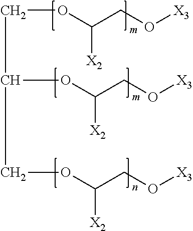

Preferably, X₂ and X₃ are independently selected from hydrogen and alkyl having 1 to 6 carbon atoms, and/or m is an integer of 1 to 20. More preferably, X₂ and X₃ are independently selected from hydrogen, methyl and ethyl, and/or m is an integer of 3 to 18. Preferred example of the cosolvent is polypropylenglycol, more preferably the polypropylenglycol has a number average molecular weight of 500 to 3,000 and most preferably of 700 to 2,000, which may be commercially available for example Nissan uniol TG1000 or BASF Pluriol P 900.

The cosolvent used in the disclosure can have a synergistic effect with CNF, which is beneficial to the orientation of the effect pigment in the composition of the disclosure. In some comparative examples, cosolvents that did not conform to the formula (I) were used, and the color performance of the obtained multilayer film was not good, and the brightness index was low. Preferably, in order to obtain better synergistic effects of the cellulose nanofiber and the cosovent, a ratio by weight of the cosolvent to the effective content of the cellulose nanofiber is from 1:1 to 6:1, more preferably from 1.5:1 to 5:1, most preferably from 2.5:1 to 4.5:1. In some embodiments of the disclosure, in order to reduce the VOC value, a weight percentage of the cosolvent is from 70.0 wt. % to 100.0 wt. %, based on total free organic solvents in the waterborne coating composition, more preferably from 80.0 wt. % to 100.0 wt. %, most preferably from 85.0 wt. % to 100.0 wt. %. This means that, in addition to the co-solvent, the disclosed composition preferably contains a small amount of other organic solvents or preferably contains no other organic solvents. In other embodiments of the disclosure, the amount of the cosolvent in the waterborne coating composition of the present disclosure is in a range of from 0.6 wt. % to 5.0 wt. % (for example 0.8 wt. %, 2.1 wt. %, 3.0 wt. %, 4.0 wt. % or 4.5 wt. %), preferably in a range of from 0.9 wt. % to 3.5 wt %, based on the weight of the coating composition.

### Effect Pigment

The waterborne coating composition of the present disclosure further comprises one or more effect pigments. One or a combination of two or more of effect pigments can be suitably selected for use, depending on the texture desired for the obtained coating film. From the standpoint of obtaining a coating film with excellent metallic luster, non-vapor deposited metal pigments are preferable. From the standpoint of obtaining a coating film with excellent pearly luster, mica pigments are preferable. The effect pigment (d) is preferably in the form of flakes.

Vapor-deposited aluminum flakes are often used in this field to improve the orientation of pigments. The present disclosure has no particularly limit on the type of effect pigments, and preferably non-vapor deposited metal pigments can be used, which are more cost advantageable. The material of the above metal is not particularly limited. Examples include aluminum, gold, silver, copper, brass, titanium, chromium, nickel, nickel chromium, stainless steel, and the like. Of these, aluminum or chromium is particularly preferable, from the standpoint of, for example, availability and convenience in handling. And aluminum flake pigment is more preferable. The aluminum flake pigment is typically produced by crushing and grinding aluminum using a grinding aid in a ball mill or attritor mill, in the presence of a grinding liquid medium. Grinding aids for use in the production step of the aluminum flake pigment include higher fatty acids, such as oleic acid, stearic acid, isostearic acid, lauric acid, palmitic acid, and myristic acid; as well as aliphatic amines, aliphatic amides, and aliphatic alcohols. Grinding liquid media for use include aliphatic hydrocarbons, such as a mineral spirit. And the aluminum flake pigment preferably has an average particle size (D50) of 1 to 50 μm, more preferably 5 to 25 μm, and particularly preferably 6 to 20 μm. The aluminum flake pigment preferably has a thickness of 0.01 to 1.0 μm, and particularly preferably 0.03 to 0.4 μm. For example, the aluminum flake pigment may be those commercial available. Examples of commercial products of flake aluminum pigment include “STAPA Hydrolan” series, “STAPA Metallux” series from ECKART and “EMERAL EX” series from Toyal etc.

“Average particle size or D50” as used herein refers to the median size in a volume-based particle size distribution measured by laser diffraction scattering with a Microtrac MT3300 particle size distribution analyzer (trade name, produced by Nikkiso Co., Ltd.). “Thickness” as used herein is defined as the average value determined by measuring the thickness using image processing software while observing the cross-sectional surface of a coating film that contains the effect pigment with a microscope, and calculating the average value of 100 or more particles.

Preferably, the amount of component (iv) in the coating composition of the present disclosure is in a range of from 0.5% to 2.0% by weight, preferably in a range of from 0.8% to 1.8% by weight, based on the weight of the coating composition.

From the standpoint of forming a pearly luster coating film, the effect pigment is preferably mica, such as natural mica, synthetic mica and/or metal oxide-coated mica pigments, more preferably natural mica and/or synthetic mica. Natural mica is a flaky base material obtained by pulverizing mica from ore. Synthetic mica is synthesized by heating an industrial material, such as SiO₂, MgO, Al₂O₃, K₂SiF₆, or NaSiF₆, to melt the material at a high temperature of about 1500° C., and cooling the melt for crystallization. When compared with natural mica, synthetic mica contains a smaller amount of impurities, and has a more uniform size and thickness. Specific examples of synthetic mica base materials include fluorophlogopite (KMg₂AlSi₃O₁₀F₂), potassium tetrasilicon mica (KMg_{2.5}AlSi₄O₁₀F₂), sodium tetrasilicon mica (NaMg_{2.5}AlSi₄O₁₀F₂), Na taeniolite (NaMg₂Li Si₄O₁₀F₂), LiNa taeniolite (LiMg₂Li Si₄O₁₀F₂), and the like. Metal oxide-coated mica pigments contain natural mica or synthetic mica as a base material, and are pigments prepared by coating the surface of the base material with a metal oxide. From the standpoint of obtaining a coating film with excellent pearly luster, the mica pigment preferably has an average particle size (D50) of 5 to 30 μm, and particularly preferably 5 to 25 μm. The mica pigment preferably has a thickness of 0.05 to 1.0 μm, and particularly preferably 0.2 to 0.7 μm.

Examples of commercial products of Pearl white flake include “Xirallic” series and “IRIODIN” series from MERCK, “Glacier Exterior Frost white” series from SunChemical etc.

The solid content of the effect pigment (d) in the waterborne coating composition of the present disclosure is preferably 0.5 wt. % to 8.0 wt. %, particularly preferably 1.0 wt. % to 7.0 wt. %, and even more preferably 3.5 wt. % to 6.0 wt. %, based on the weight of the waterborne coating composition. The use of the effect pigments, especially of the above-described non-vapor deposited metal pigments or mica pigments, in the stated total amounts, in combination with the at least one water-soluble or water-dispersible binder, at least one cellulose nanofiber material, and at least one cosolvent, leads to a particularly high brightness index.

### Other Components

The waterborne coating composition of the present disclosure, besides the above-recited mandatory component (a)-component (d), may also comprise one or more further components, such as crosslinking agents, other rheology control agents, neutralizing agents, water, surface modifiers, ultraviolet absorbers, and the like known to those skilled in the art. In some embodiments of the disclosure, the waterborne coating composition does not contain light scattering particles such as titanium oxide which may affect the orientation of effect pigments.

### Crosslinking Agent

In some embodiments of the disclosure, the disclosed composition may also include a crosslinking agent which is for use in crosslinking and curing the binder by heating. The crosslinking agent is preferably selected from the group of melamine resins, blocked polyisocynate and mixture thereof. The crosslinking agent may be used singly, or in a combination of two or more.

Melamine resin is particularly useful in the waterborne coating composition according to present disclosure. In particular, a methylated melamine resin obtained by etherifying at least partial methylol groups of a partially or fully methylolated melamine resin with methyl alcohol; a butylated melamine resin obtained by etherifying at least partial methylol groups of a partially or fully methylolated melamine resin with butyl alcohol; and a methylated/butylated melamine resin obtained by etherifying at least partial methylol groups of a partially or fully methylolated melamine resin with methyl alcohol and butyl alcohol are preferable. Examples of commercially available melamine resins useful for the waterborne basecoat composition according to present disclosure include Cymel® 202, Cymel® 203, Cymel® 211, Cymel® 251, Cymel® 303, Cymel® 324, Cymel® 325, Cymel® 327, Cymel® 350, Cymel® 385, Cymel® 1130, Cymel® 1156, Cymel® 1116, Cymel® 1158 from Allnex USA Inc; Cymel® 204, Cymel® 238, Cymel® 323 from Cytec Industries Inc.; and U-VAN™ 120, U-VAN™ 20HS, U-VAN™ 20SE60, U-VAN™ 2021, UVAN™ 2028, and U-VAN™ 28-60 from Mitsui Chemicals, Inc.

Blocked polyisocyanates can volatilize at curing temperature to regenerate the isocyanate groups. Examples of suitable blocked polyisocyanates include polyisocyanates and adducts thereof which have been modified by blocking isocyanate groups (—N═C—O group) thereof with a blocking agent. The blocking agents may be oximes such as formamide oxime, acetamide oxime, acetoxime, methyl ethyl ketoxime, diacetyl monoxime, benzophenone oxime, and cyclohexane oxime; alcohols such an methanol, ethanol, propyl alcohol, butyl alcohol, amyl alcohol, lauryl alcohol, benzyl alcohol, glycolic acid, methyl glycolate, ethyl glycolate, butyl glycolate, lactic acid, methyl lactate, ethyl lactate, butyl lactate, methylol urea, methylol melamine, diacetone alcohol, 2-hydroxyethyl acrylate, and 2-hydroxyethyl methacrylate, phenols such as phenol, cresol, xylenol, nitrophenol, ethylphenol, hydroxydiphenyl, butylphenol, isopropylphenol, nonylphenol, octylphenol, and methyl hydroxybenzoate, ethers such as ethylene glycol monomethyl ether, ethylene glycol monoethyl ether, ethylene glycol monobutyl ether, diethylene glycol monomethyl ether, diethylene glycol monoethyl ether, propylene glycol monomethyl ether, and methoxymethanol; lactams such as ε-caprolactam, δ-valerolactam, γ-butyrolactam, and β-propiolactam; active methylene compounds such as dimethyl malonate, diethyl malonate, ethyl acetoacetate, methyl acetoacetate, and acetylacetone; mercaptans such as butyl mercaptan, tert-butyl mercaptan, hexyl mercaptan, tert-dodecyl mercaptan, 2-mercaptobenzothiazole, thiophenol, methylthiophenol, and ethylthiophenol; amides such as acetanilide, acetanisidide, acetotoluide, acrylamide, methacrylamide, acetic acid amide, stearic acid amide, and benzamide; imides such as succinimide, phthalimide, and maleimide; amines such as diphenylamine, phenylnaphthylamine; xylidine, N-phenylxylidine, carbazole, aniline, naphthylamine, butylamine, dibutylamine, and butylphenylanime; imidazole or imidazole derivatives; ureas such as urea, thiourea, ethylene urea, ethylenethiourea, and diphenylurea; carbamates such as phenyl N-phenylcarbamate; imines such as ethyleneimine and propyleneimine; sulfites such as sodium bisulfite and potassium bisulfite; and azoles such as pyrazole or pyrazole derivatives. Examples of the polyisocyanates are include aliphatic polyisocyanates such as trimethylene diisocyanate, 1,2-propylene diisocyanate, tetramethylene diisocyanate, 2,3-butylene diisocyanate, hexamethylene diisocyanate, octamethylene diisocyanate, 4-isocyanatomethyl-1,8-octane diisocyanate, 2,2,4-trimethyl hexamethylene diisocyanate, 2,4,4-trimethyl hexamethylene diisocyanate, dodecamethylene diisocyanate, α,α′-dipropyl ether diisocyanate, and transvinylidene diisocyanate; alicyclic polyisocyanates, such as 1,3-cyclopentylene diisocyanate, 1,2-cyclohexylene diisocyanate, 1,4-cyclohexylene diisocyanate, 4-methyl-1,3-cyclohexylene diisocyanate, 4,4′-dicyclohexylene diisocyanate methane, 3,3′-dimethyl-4,4′-dicyclohexylene diisocyanate methane, norbornane diisocyanate, and isophorone diisocyanate; aromatic polyisocyanates such as m- and p-phenylene diisocyanate, 1,3- and 1,4-bis(isocyanate methyl)benzene, 1,5-dimethyl-2,4-bis(isocyanate methyl)benzene, 1,3,5-triisocyanate benzene, 2,4- and 2,6-toluene diisocyanate, 2,4,6-toluene triisocyanate, α,α,α′,α′-tetramethyl o-, m-, and p-xylylene diisocyanate, 4,4′-diphenylene diisocyanate methane, 4,4′-diphenylene diisocyanate, 3,3′-dichloro-4,4′-diphenylene diisocyanate, and naphthalene-1,5-diisocyanate; and any combinations thereof.

Preferably, the amount of the crosslinking agent in the coating composition of the present disclosure is in a range of from 1 wt. % to 10 wt. % (for example 2 wt. %, 3 wt. %, 5 wt. %, 8 wt. %), more preferably in a range of from 2 wt. % to 7 wt. %, more particularly in a range of from 3 wt. % to 6 wt. %, based on the total weight of the coating composition.

### Other Rheology Control Agents

The term “other rheology control agents” refer to rheological control agents other than component (b) cellulose nanofiber, which can play a thickening effect. In some embodiments of the disclosure, other rheology control agents are preferably selected from (meth)acrylic acid-(meth) acrylate copolymers and/or hydrophobically modified ethoxylated polyurethanes. (Meth)acrylic acid-(meth)acrylate copolymers are obtainable by reaction of (meth)acrylic acid with (meth)acrylic esters. Copolymers containing exclusively C1-C4 alkyl (meth)acrylates do not have an associative thickening effect (ASE thickeners). Conversely, copolymers which contain (meth)acrylates having a chain length of more than four carbon atoms do possess an associative thickening effect (HASE thickeners). Hydrophobically modified ethoxylated polyurethanes are obtainable by reaction of a diisocyanate with a polyether and subsequent reaction of this prepolymer with a hydrophobic alcohol. Such polyurethanes are also referred to as HEUR thickeners. Particularly preferred is the use of a combination of non-associative thickening (meth)acrylic acid-(meth)acrylate copolymers and hydrophobically modified ethoxylated polyurethanes.

It is preferred in this context if the at least one thickener, more particularly (meth)acrylic acid-(meth) acrylate copolymers and/or hydrophobically modified ethoxylated polyurethanes, is present in a total amount of 0.05 to 3.0 wt. %, preferably of 0.1 to 2.0 wt. %, more preferably of 0.2 to 1.5 wt. %, based on the total weight of the coating composition.

According to one particularly preferred embodiment of the present disclosure, the aqueous coating material comprises no inorganic rheology control agent and/or polyamides, more particularly no phyllosilicates (or layered silicates) and no polyamides. This means that the phyllosilicates and/or polyamides, more particularly phyllosilicates and polyamides, are present in a total amount of 0 wt. %, based on the total weight of the coating composition. Surprisingly, the use of cellulose nanofibers without additional use of polyamides and/or phyllosilicates leads to excellent color performance and stable shear viscosity.

### Neutralizing Agents

The neutralizing agent is preferably selected from the group of inorganic bases, primary amines, secondary amines, tertiary amines, and mixtures thereof, especially diethylethanolamine, with reasonable boiling point and evaporation speed.

It is preferred in this context if the at least one neutralizing agent, especially diethylethanolamine, is present in a total amount of 0.3 to 3.0 wt. %, preferably of 0.5 to 2.0 wt. %, more preferably of 0.7 to 1.5 wt. %, based on the total weight of the coating composition. The use of the neutralizing agent, especially diethylethanolamine, in the quantity ranges recited above, in combination with the cosolvent, ensures sufficient solubilization of the binder and hence provides good storage stability.

### Water

Water may be selected from a group consisting of deionized water, distilled water, and pure water, preferably deionized water.

Preferably, the amount of free water (except the water inside of the binder and additives) in the coating composition of the present disclosure is in a range of from 20 wt. % to 60 wt. % by weight (for example 25 wt. %, 30 wt. %, 40 wt. %, 50 wt. % or 55 wt. %), preferably in a range of from 30 wt. % to 50 wt. %, more preferably in a range of from 35 wt. % to 46 wt. % by weight based on the total weight of the coating composition.

It could be understood that the waterborne coating composition according to the present disclosure may have already include the total amount of water medium such that a suitable viscosity for the purpose of painting could be provided. It is also possible that the waterborne basecoat composition according to the present disclosure may be diluted to the suitable viscosity by the addition of further water and/or by means of a small amount of organic solvent prior to painting.

### Surface Modifiers and Ultraviolet Absorbers

Surface modifiers mainly promotes the coating to form a flat, smooth and uniform film in the process of drying film, such as acrylic and silicone leveling agents. Examples of commercial products of the surface adjusting agent include BYK series (produced by BYK-Chemie), Tego series (produced by Evonik) and Surfynol series (produced by Evonik).

A known ultraviolet absorber may be used. Examples thereof include benzotriazole absorbers, triazine absorbers, salicylic acid derivative absorbers, benzophenone absorbers, and other ultraviolet absorbers. Commercial products such as Tinuvin 384-2, Tinuvin 123 produced by BASF.

The amount of the surface modifiers or ultraviolet absorbers in the coating composition of the present disclosure may be determined by a skilled person according to practical application.

There are no particular restrictions on the method for preparing the waterborne coating composition according to the present disclosure. Any methods known in the art such as kneading a mixture of the aforesaid resins and pigments, etc., and dispersing by means of a ball mill, sand mill, disperser, or the like, may be used.

The waterborne coating composition of the present disclosure can be prepared by a skilled person using a process known in the art. For example, the coating composition of the present disclosure may be prepared by adding all the components step by step with stirring. Preferably, before forming the coating composition of the present disclosure, when the effect pigments are used in form of dry powders or particles, they are pre-dispersed in a binder and/or a solvent to form a pre-dispersion respectively. The binder and the solvent used for forming the pre-dispersion are those applicable for the present disclosure. Preferably, the binder and the solvent used for forming the pre-dispersion are parts of the binder and the cosolvent in the coating composition of the present disclosure. In a preferred embodiment, effect pigments disperse well in polyester resin and cosolvent and there is no particles and agglomeration in the pre-dispersion. Using the cosolvent of the present disclosure can greatly improve the dispersion of effect pigments, especially non-vapor deposited metal pigments, so there is no need to use other dispersants in the effect pigment pre-dispersion.

The waterborne coating composition according to the present disclosure may be applied by any conventional coating methods, such as air spray coating, air atomized electrostatic coating, rotational bell atomized electrostatic coating, and the like, preferably following prior application of an undercoat layer comprising an electrodeposition coating material and/or a sealing material for example in an automotive painting process.

Generally, the waterborne coating composition according to the present disclosure is applied such that a coating film having a thickness of greater than 5 μm, preferably 6 to 20 μm may be obtained after curing, and then cured, for example at a temperature in the range from 100 to 200° C., preferably from 120 to 160° C., for a suitable time, such as from 10 minutes to 1 hour, and a cured coating film is thus obtained. The cured coating film has a relatively high dry film thickness, which can not only ensure the color effect, but also significantly indicate the mechanical properties of the film (such as impact resistance, etc.).

The present disclosure further relates to a coated article having the cured coating film on an object, the cured coating film being obtained by curing the waterborne coating composition of the disclosure. Many different types of objects can be used in the present disclosure, including metal or metallic objects such as bare steel, phosphated steel, galvanized steel, or aluminum; and non-metallic objects, such as plastics and composites.

A further subject of the present disclosure is the use of the waterborne coating composition of the disclosure for the production of the pigmented aqueous coating materials. Applications of the pigmented aqueous coating materials include but are not limited to automobile, railway rolling stock, bridge pipeline, steel structure, interior and exterior walls of architectural engineering, furniture and other industrial fields, preferably, automotive filed, more preferably, the pigmented aqueous coating materials of the present disclosure is suitable for automotive basecoat materials.

A multilayer coating film comprising a basecoat layer obtained by application of the waterborne coating composition and a clearcoat layer on the basecoat layer has a brightness index of greater than or equal to 0.20, preferably of greater than or equal to 0.22, more preferably of greater than or equal to 0.30 and/or less than or equal to 0.50, wherein the brightness index=(L*_{15°}−L*_{25°})/L*_{15°}, L*_{15°} and L*_{25°} respectively represent lightness values measured at viewing angles of 15° and 25° with 45° of light source illumination according to the L*a*b* color system (CIE lab). According to the lightness values of the film obtained by different types of effect pigments, the appropriate viewing angles in the brightness index formula are determined. Regarding to the brightness of this combination, the brightness index can achieve relatively high value and this means a high light reflection of the multilayer coating film of the disclosure and high effect pigment orientation has been realized in low VOCs containing the waterborne coating composition according to the present disclosure. Preferably, the multilayer coating film also has a graininess Gdiff (G*) of less than or equal to 4, especially preferably less than or equal to 3.7. It means that the film of the disclosure has a higher smoothness. In an embodiment of the disclosure, the multilayer coating film has a super shining silver color effect, G* value is less than 4, corresponding brightness index is preferably above 0.3 and L*_{110°} is less than 10 (L*_{110°} represents lightness value measured at viewing angles of 110° with 45° of light source illumination according to the L*a*b* color system (CIE lab)). In another embodiment of the disclosure, the multilayer coating film has a silky pearl white color effect, G* value is preferably less than 2.5 and corresponding brightness index is preferably above 0.2.

### Method for Producing a Multilayer Coating Film

The disclosure also provides a method for producing a multilayer coating film, the method comprising the following steps:
(1) optionally producing a cured first coating layer on the substrate by application of a coating material to the substrate and subsequent curing of the composition;
(2) producing one or more basecoat layers on the coating layer obtained in step (1) by application of one or more identical or different aqueous basecoat materials;
(3) producing one or more clearcoat layers on the one or the topmost basecoat layer by application of one or more identical or different clearcoat materials;
and (4) jointly curing the one or more basecoat layers and the one or more clearcoat layers;

wherein at least one of the basecoat materials is the waterborne coating composition according to the disclosure.

In the method of the disclosure, a multicoat paint system is built up on a substrate.

With preference in accordance with the disclosure, the substrate is selected from metallic substrates, plastics, glass and ceramics, more particularly from metallic substrates. Metallic substrates contemplated essentially include substrates comprising or consisting of, for example, iron, aluminum, copper, zinc, magnesium, and alloys thereof, and also steel, in any of a very wide variety of forms and compositions. Preferred substrates are those of iron and steel, especially being typical iron and steel substrates as used in the automotive industry sector. Before step (1) of the method of the disclosure, the metallic substrates may be pretreated in a conventional way—that is, for example cleaned. Suitable plastics substrates are in principle substrates comprising or consisting of (i) polar plastics, such as polycarbonate, polyamide, polystyrene, styrene copolymers, polyesters, polyphenylene oxides, and blends of these plastics, (ii) reactive plastics, such as PUR-RIM, SMC, BMC, and also (iii) polyolefin substrates of the polyethylene and polypropylene types with a high rubber content, such as PP-EPDM, and also surface-activated polyolefin substrates. The plastics may also be fiber-reinforced, more particularly using carbon fibers and/or metal fibers. Substrates of plastic as well may be pretreated, more particularly by cleaning, before step (1) of the method of the disclosure, in order to improve the adhesion of the first coating layer. As substrates it is also possible, moreover, to use those which contain both metallic and plastics fractions. Substrates of this kind are, for example, vehicle bodies containing plastics parts.

### Step (1)

In step (1) of the method of the disclosure, a cured first coating layer may be produced on the substrate by application of a coating material to the substrate and optional subsequent curing.

The coating material of step (1) may be an electrocoat coating material. The first coating layer is preferably a cured electrocoat layer having a thickness such as in a range of 8 to 18 μm.

### Step (2)

In step (2) of the method of the disclosure, one basecoat layer is produced (Alternative 1), or two or more directly consecutive basecoat layers are produced (Alternative 2).

The layers are produced by application of an waterborne coating composition directly to the substrate or directly to the cured coating layer obtained in step (1) or by directly consecutive application of two or more basecoat materials to the substrate or to the cured coating layer obtained in step (1).

After having been produced, therefore, the basecoat layer according to Alternative 1 of step (2) is disposed directly on the cured coating layer obtained in step (1).

The directly consecutive application of two or more basecoat materials to the cured coating layer obtained in step (1) (Alternative 2) is understood as follows: The application of the first basecoat material produces a first basecoat layer directly on the cured first coat of step (1). The at least one further basecoat layer is then produced directly on the first basecoat layer. Where two or more further basecoat layers are produced, they are produced directly consecutively. For example, precisely one further basecoat layer can be produced, which in that case, in the multicoat paint system ultimately produced, is disposed directly below the first or only clearcoat layer.

The basecoat materials may be identical or different. It is also possible to produce two or more basecoat layers with the same basecoat material, and one or more further basecoat layers with one or more other basecoat materials. At least one of the aqueous basecoat materials used in step (2), however, comprises the waterborne coating composition of the disclosure.

Embodiments preferred in the context of the present disclosure encompass, according to Alternative 2 of step (2) of the method of the disclosure, the production of two or more basecoat layers. And the aqueous basecoat materials used in step (2) comprises primer coating material (such as N-3000 N6 from BASF Coatings GmbH) and the waterborne coating composition of the disclosure.

The basecoat layers are cured not separately but rather together with the clearcoat material. In particular, the coating materials as used in step (2) of the method of the disclosure are not cured separately like the coating materials referred to as surfacers in the context of the standard method. The basecoat layers are therefore preferably not exposed to temperatures of above 100° C. for a time of longer than 1 minute, and with particular preference are not exposed at all to temperatures of more than 100° C. in step (2).

The basecoat materials are applied such that, after the curing in step (4), the basecoat layer and the individual basecoat layers each have a layer thickness of, for example, great than 5 μm. Preferably a primer layer has a thickness after cured such as in a range of 12 to 18 μm and the waterborne coating layer cured by the waterborne coating composition according to the present disclosure has a thickness of 6 to 15 μm.

### Step (3)

In step (3) of the method of the disclosure, one or more clearcoat layers are produced directly on the one basecoat layer or on the topmost basecoat layer by application of one or more identical or different clearcoat materials. Preferly, one clearcoat layer is produced on the one basecoat layer. Suitable clearcoat materials are commercially available, such as ProGloss®, from BASF Coatings GmbH.

The layer thickness of the individual clearcoat layer after the curing in step (4) is from, for example, 15 to 80 μm, preferably 20 to 65 μm, especially preferably 25 to 60 μm.

### Step (4)

In step (4) of the method of the disclosure, there is joint curing of the basecoat layer and of the clearcoat layer, or of the basecoat layers and of the clearcoat layer. The joint curing takes place preferably at temperatures of 100 to 250° C., preferably 100 to 180° C., for a duration of 5 to 60 minutes, preferably 10 to 45 minutes. The method of the disclosure allows the production of multicoat paint systems on substrates without a separate curing step.

In an embodiment of the disclosure, a multilayer coating film is prepared with a process comprising:
(1) applying the electrocoat material to a substrate of an article and dryling the material at at temperatures of 120 to 180° C. to form the cured first coating layer;
(2a) applying a primer material to the cured first coating layer, flashing off the composition at room temperature for a duration of 3 to 6 minutes, and finally the obtained primer dry film preferably has a thickness in a range of 12 to 18 μm;
(2b) optionally repeat step (2a);
(3) applying a waterborne coating composition of the present disclosure on the primer film or films formed in step (2a) or step (2b), flashing off the coating composition at room temperature for a duration of 3 to 6 minutes and then at temperatures of 50 to 80° C. for a duration of 3 to 6 minutes, and finally the obtained coating dry film preferably has a thickness in a range of 6 to 15 μm; and
(4) applying a clearcoat material on the coating film formed in step (3), then flashing off the clearcoat material at room temperature for a duration of 5 to 10 minutes and then drying at temperatures of 120 to 160° C. for a duration of 20 to 40 minutes, to form a clearcoat film preferably having a thickness in a range of 30 to 60 μm, thereby forming the multilayer coating film on the substrate.

Preferably, a multilayer coating film is prepared with an integrated process and the multilayer coating film comprises one or two primer layers, only one basecoat layer and only one clearcoat layer. This process can compress process flow, reduce operation cost, reduce equipment investment, and reduce energy consumption, at the same time, the obtained multilayer coating film has an excellent color performance.

### Multilayer Coating Film

After the end of step (4) of the method of the disclosure, the result is a multilayer coating film of the disclosure. The present disclosure further provides a multilayer coating film having a distinctive color performance. Specifically, the film has a brightness index of greater than or equal to 0.20, preferably of greater than or equal to 0.22, wherein the brightness index=(L*_{15°}−L*_{25°})/L*_{15°}, L*_{15°} and L*_{25°} respectively represent lightness values measured at viewing angles of 15° and 25° according to the L*a*b* color system (CIE lab). Whether the effect pigment of the disclosed composition is selected from metallic pigment or mica, the obtained multilayer coating film can meet the requirement of the brightness index. Preferably, the multilayer coating film also has a graininess Gdiff (G*) of less than or equal to 4, especially preferably less than or equal to 3.7.

The present disclosure further relates to a colored article having the multilayer coating film. The colored article of the present disclosure can be obtained by a skilled person with conventional procedures.

### EMBODIMENTS

### Embodiment 1

A waterborne coating composition comprising
a) a water-soluble or water-dispersible binder;
b) a cellulose nanofiber;
c) a cosolvent of the formula (I)

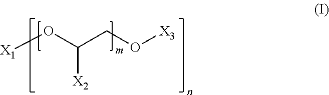

wherein
the combination of X₁ and n is (X₁, n)=(H, 1) or (CH₂—CH—CH₂, 3),
X₂ and X₃ are independently selected from hydrogen and alkyl having 1 to 8 carbon atoms, and m is an integer of 1 to 30; and
d) an effect pigment;
wherein
the waterborne coating composition has a volatile organic content of less than or equal to 420 g/L without water;
a multilayer coating film comprising a basecoat layer obtained by application of the waterborne coating composition and a clearcoat layer on the basecoat layer has a brightness index of greater than or equal to 0.20, wherein the brightness index=(L*_{15°}−L*_{25°})/L*_{15°}, L*_{15°} and L*_{25°} respectively represent lightness values measured at viewing angles of 15° and 25° according to the L*a*b* color system (CIE lab).

### Embodiment 2

The waterborne coating composition according to embodiment 1, wherein the composition further comprises e) a crosslinking agent.

### Embodiment 3

The waterborne coating composition according to embodiment 1 or embodiment 2, wherein said water-soluble or water-dispersible binder (a) comprises at least one selected from following resins: acrylic resin, polyurethane resin, acrylic-urethane resin, polyester resin, polyether resin, alkyd resin, polycarbonate resin and epoxy resin.

### Embodiment 4

The waterborne coating composition according to any one of embodiments 1 to 3, wherein said cosolvent (c) has a boiling point of at least 140° C. and has an HLB value of at least 9.

### Embodiment 5

The waterborne coating composition according to any one of embodiments 1 to 4, wherein said effect pigment (d) comprises at least one selected from non-vapor-deposited metallic pigment and mica.

### Embodiment 6

The waterborne coating composition according to any one of embodiments 1 to 5, wherein said effect pigment (d) has a particle size of 5 to 25 μm.

### Embodiment 7

The waterborne coating composition according to any one of embodiments 1 to 6, wherein said crosslinking agent (e) comprises at least one selected from melamine resin and blocked polyisocyanate.

### Embodiment 8

The waterborne coating composition according to any one of embodiments 1 to 7, wherein an effective content of the cellulose nanofiber (b) is from 0.35 wt. % to 0.80 wt. %, based on the total weight of the waterborne coating composition.

### Embodiment 9

The waterborne coating composition according to embodiment 8, wherein a ratio by weight of the cosolvent (c) to the effective content of the cellulose nanofiber (b) is from 1:1 to 6:1.

### Embodiment 10

The waterborne coating composition according to any one of embodiments 1 to 9, wherein a weight percentage of the cosolvent (c) is from 70.0 wt. % to 100.0 wt. %, based on total free organic solvents in the waterborne coating composition.

### Embodiment 11

The waterborne coating composition according to any one of embodiments 1 to 10, wherein the waterborne coating composition has a solid content of greater than 15 wt. %.

### Embodiment 12

The waterborne coating composition according to any one of embodiments 1 to 11, wherein the waterborne coating composition has a volatile organic content of less than or equal to 150 g/L (water in).

### Embodiment 13

The waterborne coating composition according to any one of embodiments 1 to 12, wherein the waterborne coating composition has a thixotropy value (Ti value) of less than or equal to 40, wherein the Ti value=η(A)/η(B), η(A) is viscosity under a shearing rate of 1000 s⁻¹ and η(B) is viscosity under a shearing rate of 1 s⁻¹, measured using a rotational viscometer at 23° C.

### Embodiment 14

The waterborne coating composition according to any one of embodiments 1 to 13, wherein the multilayer coating film has a graininess Gdiff (G*) of less than or equal to 4.

### Embodiment 15

A coating film obtained from the waterborne coating composition according to any one of embodiments 1 to 14, wherein a dry film thickness of the coating film is greater than 5 μm.

### Embodiment 16

A coated article comprising a cured coating film on an object, the cured coating film being obtained by curing the waterborne coating composition according to any one of embodiments 1 to 14.

### Embodiment 17

A method for producing a multilayer coating film, comprising:
(1) optionally producing a cured first coating layer on the substrate by application of a coating material to the substrate and subsequent curing of the composition;
(2) producing one or more basecoat layers on the coating layer obtained in step (1) by application of one or more identical or different aqueous basecoat materials;
(3) producing one or more clearcoat layers on the one or the topmost basecoat layer by application of one or more identical or different clearcoat materials;
and (4) jointly curing the one or more basecoat layers and the one or more clearcoat layers;
wherein at least one of the basecoat materials is the waterborne coating composition according to any one of embodiments 1 to 14.

### Embodiment 18

A multilayer coating film obtainable by the method according to embodiment 17.

### Embodiment 19

The multilayer coating film according to embodiment 18, wherein the multilayer coating film has a brightness index of greater than or equal to 0.20, wherein the brightness index=(L*_{15°}−L*_{25°})/L*_{15°}, L*_{15°} and L*_{25°} respectively represent lightness values measured at viewing angles of 15° and 25° according to the L*a*b* color system (CIE lab), and a graininess Gdiff (G*) of less than or equal to 4.

### Embodiment 20

A use of the waterborne coating composition according to any one of embodiments 1 to 14 for the production of the pigmented aqueous coating materials.

### EXAMPLES

The present disclosure will be better understood in view of the following non-limiting examples. The examples do not limit the scope of the disclosure as described and claimed.

### Description of Methods

### Solid Content (%)

The solid content was determined in accordance with DIN EN ISO 3251 (date: June 2008). It involves weighing out 1 g of sample into an aluminum foil which has been dried beforehand, drying it in a drying oven at 125° C. for 60 minutes, cooling it in a desiccator and then reweighing it. The residue relative to the total amount of sample used corresponds to the solid content or the nonvolatile fraction.

$$Solid mass = sample mass \times solid content ( \% ) .$$

### Dry Film Thickness

The dry film thicknesses were determined according to DIN EN ISO 2808:2007-05 (date: May 2007), method 12A-Magnetic-induction gauge, using the FMP20 instrument from Helmut-Fischer company.

### VOC

The volatile organic content (VOC water in) was determined in accordance with GB/T 23986-2009 10.3 by gas-Chromatographic method. The volatile organic compound content without water (VOC water out) was determined in accordance with GB/T 23986-2009 10.4 by gas-Chromatographic method.

### Brightness Index and Graininess Gdiff (G*)

For determining the G*, a substrate coated accordingly (multicoat system as in Section 2 of the Working Examples below) was measured by BYK mac i from BYK-Chemie GmbH, with diffuse illumination, to evaluate or measure graininess, the non-uniformity of light/dark areas is evaluated, and these areas are recorded by the CCD camera to provide a gray-scale picture. The uniformity of this image is a measurement of graininess.

For determining the brightness index, a substrate coated accordingly (multicoat system as in Section 2 of the Working Examples below) was measured by BYK mac i from BYK-Chemie GmbH, with 45° of D65 light source illumination and viewing aspecular is −15°, 15°, 25°, 45°, 75° and 110°. From the lightness values determined for the viewing angles of 15° and 25°, it is possible to calculate a brightness index according to the formula:

$$Brightness index = ( {L}_{15 °}^{⋆} - {L}_{25 °}^{⋆} ) / {L}_{15}^{⋆}$$

where L* stands for the lightness value measured at the respective measuring angle (15° and 45°).

### Thixotropy Value (Ti Value)

The Ti value was determined in accordance with the formula:
Ti value=η(A)/η(B), where η(A) is viscosity under a shearing rate of 1000 s⁻¹ and η(B) is viscosity under a shearing rate of 1 s⁻¹, measured measured using a rotary viscometer (MCR 302, from Anton Paar) at 23° C.

### Working Examples

The following should be taken into account regarding the formulation constituents and amounts thereof indicated. When reference is made to a commercial product or to a preparation protocol described elsewhere, the reference, independently of the principal designation selected for the constituent in question, is to precisely this commercial product or precisely the product prepared with the referenced protocol.

Accordingly, where a formulation constituent possesses the principal designation “acrylic resin” and where a commercial product is indicated for this constituent, the acrylic resin is used in the form of precisely this commercial product. Any further constituents present in the commercial product, such as solvents, must therefore be taken into account if conclusions are to be drawn about the amount of the active substance (of the acrylic resin).

If, therefore, reference is made to a preparation protocol for a formulation constituent, and if such preparation results, for example, in a polymer dispersion having a defined nonvolatile fraction, then precisely this dispersion is used. The overriding factor is not whether the principal designation that has been selected is the term “polymer dispersion” or merely the active substance, for example, “polymer”, “polyester”, or “polyurethane-modified polyacrylate”. This must be taken into account if conclusions are to be drawn concerning the amount of the active substance (of the polymer).

### 1. Preparation and Evaluation of Waterborne Coating Compositions (Super Shining Silver)

Preparation of a pigment dispersion paste: 1 parts of cosolvent (Pluriol® P 900, from BASF), 0.8 parts of polyester resin (Uralac SN800, DSM, solid content of about 63 wt. %) and 9.7 parts of aluminum flake pigment (EMR 4670, from Toyo aluminum Co., Ltd., average particle diameter D50:8 μm, particle size tested under ASTM D7928-16, standard test method for particle size distribution of fine-grained soils using the sedimentation analysis, solid content of about 56 wt. %) were mixed to obtain a pigment dispersion paste.

Preparation of CNF Solution: A cellulose nanofiber solution (CNF solution) was prepared from dry Celluforce NCV-100 by stepwise addition of solid CNF to deionized water while stirring vigorously. After reaching the desired amount of 3 wt. % CNF in water, stirring was continued until a clear solution was formed.

13.9 parts of polyurethane resin (DAOTAN® TW 1237/32WA, from Allnex, solid content of about 32 wt. %), 4.2 parts of acrylic resin (NeoCryl XK-110, from DSM, solid content of about 46 wt. %), 1.4 parts of a type A rheology control agent (Rheovis AS 1130, from BASF, solid content of about 29 wt. %), 20.8 parts of a type B rheology control agent (CNF Solution), 0.6 parts of an ultraviolet absorber (Tinuvin 123, from BASF), 0.4 parts of a surface modifier (BYK346, from BYK, solid content of about 50 wt. %), and 41.6 parts of deionized water were introduced into a container. Next, 5.5 parts of a melamine resin (Cymel 202, Cymel 303, from Allnex, solid content of about 80 wt. %), 1.1 parts of diethylethanolamine and 11.5 parts of the pigment dispersion paste were added and uniformly stirred to obtain a waterborne coating composition S-1.

A series of waterborne coating compositions S2 to S15 were prepared according to the components and amounts provided in Table 1, Table 3 and Table 5, wherein pH of each obtained waterborne coating composition was adjusted to 8.2.

The obtained waterborne coating compositions were applied as a basecoat. Solid content, viscosity and VOC value of these compositions were determined. The measurement results were shown in Table 2, Table 4 and Table 6.

### 2. Production and Evaluation of Multilayer Coating Films (Super Shining Silver)

Steel panels coated with a standard cathodic electrocoat material (CathoGuard® 800 gray from BASF Coatings) were employed. Using an ESTA bell (EcoBell III, from Dürr Systems AG, Germany), the primer coating material (N-3000 N6, from BASF Coatings GmbH) was applied to the panels and the material was flashed off at room temperature for 5 minutes. A dry primer film thickness was 15 μm.

Afterwards, the waterborne coating composition (Super Shining Silver) was applied by means of a rotary atomizer (EcoBell II, from Dürr Systems AG, Germany) (outflow rate of 380 mL/min, rotational speed: 40,000 rpm, voltage: 60 kv) at a temperature of 23° C. and a humidity of 65% so as to provide a dry film thickness of 7 μm. Following the painting, the panels were left at room temperature for 5 minutes and then flashed off at 70° C. for 5 minutes. After cooling to 23° C., a clearcoat paint (ProGloss®, from BASF Coatings GmbH) was applied so as to provide a dry film thickness of 45 μm. Following the painting, the panels were left for 10 minutes and then baked horizontally at 140° C. for 30 minutes, to obtain the final panels with multilayer coating films.

The produced multilayer coating films were evaluated for color performance in terms of brightness index and graininess. The measurement results were summarized in Table 2, Table 4 and Table 6.

TABLE 1

| | | S-1 | | S-2 | | S-3 | | S-4 | | S-5* | | S-6* | |
|---|---|---|---|---|---|---|---|---|---|---|---|---|---|
| | | | Solid | | Solid | | Solid | | Solid | | Solid | | Solid |
| Components | | Mass | Mass | Mass | Mass | Mass | Mass | Mass | Mass | Mass | Mass | Mass | Mass |
| Rheology | Type A Rheovis AS | 1.4 | 0.4 | 1.4 | 0.4 | 1.4 | 0.4 | 1.4 | 0.4 | 1.4 | 0.4 | 1.4 | 0.4 |
| Control | 1130 (ASE) | | | | | | | | | | | | |
| Agent | Type B CNF solution | 20.8 | 0.63 | 20.8 | 0.63 | 20.8 | 0.63 | 20.8 | 0.63 | 20.8 | 0.63 | 20.8 | 0.63 |
| | (3%) | | | | | | | | | | | | |
| Ultraviolet | Tinuvin 123 | 0.6 | 0.6 | 0.6 | 0.6 | 0.6 | 0.6 | 0.6 | 0.6 | 0.6 | 0.6 | 0.6 | 0.6 |
| Absorber | | | | | | | | | | | | | |
| Surface | BYK346 | 0.4 | 0.2 | 0.4 | 0.2 | 0.4 | 0.2 | 0.4 | 0.2 | 0.4 | 0.2 | 0.4 | 0.2 |
| Modifier | | | | | | | | | | | | | |
| Binder | Polyurethane | 13.9 | 4.5 | 13.9 | 4.5 | 13.9 | 4.5 | 13.9 | 4.5 | 13.9 | 4.5 | 13.9 | 4.5 |
| | Acrylic resin | 4.2 | 1.9 | 4.2 | 1.9 | 4.2 | 1.9 | 4.2 | 1.9 | 4.2 | 1.9 | 4.2 | 1.9 |
| | Polyester resin | 0.8 | 0.5 | 0.8 | 0.5 | 0.8 | 0.5 | 0.8 | 0.5 | 0.8 | 0.5 | 0.8 | 0.5 |
| Crosslinking | Melamine resin | 5.5 | 4.4 | 5.5 | 4.4 | 5.5 | 4.4 | 5.5 | 4.4 | 5.5 | 4.4 | 5.5 | 4.4 |
| Agent | | | | | | | | | | | | | |
| Cosolvent | Polypropylenglycol | 1.0 | 1.0 | 0.0 | | 0.0 | | 0.0 | | 0.0 | | 0.0 | |
| | Butyl glycol | 0.0 | | 2.0 | | 0.0 | | 0.0 | | 0.0 | | 0.0 | |
| | Butyldiglycol | 0.0 | | 0.0 | | 2.0 | | 0.0 | | 0.0 | | 0.0 | |
| | Ethylene glycol | 0.0 | | 0.0 | | 0.0 | | 2.0 | | 0.0 | | 0.0 | |
| | Ethyl Hexanol | 0.0 | | 0.0 | | 0.0 | | 0.0 | | 2.0 | | 0.0 | |
| | Texanol | 0.0 | | 0.0 | | 0.0 | | 0.0 | | 0.0 | | 2.0 | |
| Neutralizing | Diethylethanolamine | 1.1 | | 1.1 | | 1.1 | | 1.1 | | 1.1 | | 1.1 | |
| agent | | | | | | | | | | | | | |
| Deionized | | 41.6 | | 41.6 | | 41.6 | | 41.6 | | 41.6 | | 41.6 | |
| Water | | | | | | | | | | | | | |
| Aluminum | EMR 4670 | 9.7 | 5.4 | 9.7 | 5.4 | 9.7 | 5.4 | 9.7 | 5.4 | 9.7 | 5.4 | 9.7 | 5.4 |
| Flake | | | | | | | | | | | | | |
| Pigment | | | | | | | | | | | | | |
| Total | | 101 | | 102 | | 102 | | 102 | | 102 | | 102 | |

TABLE 2

| | | S-1 | S-2 | S-3 | S-4 | S-5* | S-6* |
|---|---|---|---|---|---|---|---|
| Wet film | Solid content(%) | 19.4% | 18.4% | 18.4% | 18.4% | 18.4% | 18.4% |
| properties | pH value | 8.2 | 8.2 | 8.2 | 8.2 | 8.2 | 8.2 |
| | η(A) | 60 | 60 | 60 | 60 | 60 | 60 |
| | η(B) | 1755 | 2000 | 1650 | 1750 | 5798 | 4920 |
| | Ti (η(A)/ η(B)) | 26.3 | 33.3 | 27.5 | 21.8 | 96 | 82 |
| | VOC(water in), g/L | 118 | 145 | 145 | 145 | 145 | 145 |
| | VOC(water out), g/L | 278 | 407 | 407 | 407 | 407 | 407 |
| Dry film | Film thickness, μm | 7 | 7 | 7 | 7 | 7 | 7 |
| properties | Clearcoat film thickness, μm | 45 | 45 | 45 | 45 | 45 | 45 |
| | Primer film thickness, μm | 15 | 15 | 15 | 15 | 15 | 15 |
| Color | Brightness index | 0.3 | 0.32 | 0.32 | 0.31 | 0.19 | 0.15 |
| performance | G* | 3.2 | 3 | 2.9 | 3 | 4.5 | 4.8 |

TABLE 3

| | | S-7* | | S-8 | | S-9 | | S-10 | | S-11 | |
|---|---|---|---|---|---|---|---|---|---|---|---|
| | | | Solid | | Solid | | Solid | | Solid | | Solid |
| Components | | Mass | Mass | Mass | Mass | Mass | Mass | Mass | Mass | Mass | Mass |
| Rheology | Type A Rheovis AS | 1.4 | 0.4 | 1.4 | 0.4 | 1.4 | 0.4 | 1.4 | 0.4 | 1.4 | 0.4 |
| Control | 1130 (ASE) | | | | | | | | | | |
| Agent | Type B CNF solution | 10 | 0.3 | 15 | 0.45 | 20.8 | 0.63 | 25 | 0.75 | 30 | 0.9 |
| | (3%) | | | | | | | | | | |
| Ultraviolet | Tinuvin 123 | 0.6 | 0.6 | 0.6 | 0.6 | 0.6 | 0.6 | 0.6 | 0.6 | 0.6 | 0.6 |
| Absorber | | | | | | | | | | | |
| Surface | BYK346 | 0.4 | 0.2 | 0.4 | 0.2 | 0.4 | 0.2 | 0.4 | 0.2 | 0.4 | 0.2 |
| Modifier | | | | | | | | | | | |
| Binder | Polyurethane | 13.9 | 4.5 | 13.9 | 4.5 | 13.9 | 4.5 | 13.9 | 4.5 | 13.9 | 4.5 |
| | Acrylic resin | 4.2 | 1.9 | 4.2 | 1.9 | 4.2 | 1.9 | 4.2 | 1.9 | 4.2 | 1.9 |
| | Polyester resin | 0.8 | 0.5 | 0.8 | 0.5 | 0.8 | 0.5 | 0.8 | 0.5 | 0.8 | 0.5 |
| Crosslinking | Melamine resin | 5.5 | 4.4 | 5.5 | 4.4 | 5.5 | 4.4 | 5.5 | 4.4 | 5.5 | 4.4 |
| Agent | | | | | | | | | | | |
| Cosolvent | Ethylene glycol | 2.0 | | 2.0 | | 2.0 | | 2.0 | | 2.0 | |
| Neutralizing | Diethylethanolamine | 1.1 | | 1.1 | | 1.1 | | 1.1 | | 1.1 | |
| agent | | | | | | | | | | | |
| Deionized | | 41.6 | | 41.6 | | 41.6 | | 41.6 | | 41.6 | |
| water | | | | | | | | | | | |
| Aluminum | EMR 4670 | 9.7 | 5.4 | 9.7 | 5.4 | 9.7 | 5.4 | 9.7 | 5.4 | 9.7 | 5.4 |
| Flake | | | | | | | | | | | |
| Pigment | | | | | | | | | | | |
| Total | | 91.2 | | 96.2 | | 102 | | 106.2 | | 111.2 | |

TABLE 4

| | | S-7* | S-8 | S-9 | S-10 | S-11 |
|---|---|---|---|---|---|---|
| Wet film | Solid content(%) | 20.7% | 19.8% | 18.4% | 18.2% | 17.4% |
| properties | pH value | 8.2 | 8.2 | 8.2 | 8.2 | 8.2 |
| | η(A) | 60 | 60 | 60 | 60 | 60 |
| | η(B) | 1515 | 1816 | 2000 | 2178 | 2470 |
| | Ti (η(A)/ η(B)) | 25 | 30.2 | 33.3 | 36.3 | 41.0 |
| | VOC(water in), g/L | 133 | 137 | 145 | 145 | 150 |
| | VOC(water out), g/L | 407 | 407 | 407 | 407 | 407 |
| Dry film | Film thickness, μm | 7 | 7 | 7 | 7 | 7 |
| properties | Clearcoat film thickness, μm | 45 | 45 | 45 | 45 | 45 |
| | Primer film thickness, μm | 15 | 15 | 15 | 15 | 15 |
| Color | Brightness index | 0.17 | 0.24 | 0.32 | 0.32 | 0.22 |
| performance | G* | 4.5 | 3.5 | 3 | 3 | 3.6 |

TABLE 5

| | | S-12* | | S-13 | | S-14 | | S-15* | |
|---|---|---|---|---|---|---|---|---|---|
| | | | Solid | | Solid | | Solid | | Solid |
| Components | | Mass | Mass | Mass | Mass | Mass | Mass | Mass | Mass |
| Rheology | Type A Rheovis AS | 1.4 | 0.4 | 1.4 | 0.4 | 1.4 | 0.4 | 1.4 | 0.4 |
| Control | 1130 (ASE) | | | | | | | | |
| Agent | Type B CNF solution | 20.8 | 0.63 | 20.8 | 0.63 | 20.8 | 0.63 | 20.8 | 0.63 |
| | (3%) | | | | | | | | |
| Ultraviolet | Tinuvin 123 | 0.6 | 0.6 | 0.6 | 0.6 | 0.6 | 0.6 | 0.6 | 0.6 |
| Absorber | | | | | | | | | |
| Surface | BYK346 | 0.4 | 0.2 | 0.4 | 0.2 | 0.4 | 0.2 | 0.4 | 0.2 |
| Modifier | | | | | | | | | |
| Binder | Polyurethane | 13.9 | 4.5 | 13.9 | 4.5 | 13.9 | 4.5 | 13.9 | 4.5 |
| | Acrylic resin | 4.2 | 1.9 | 4.2 | 1.9 | 4.2 | 1.9 | 4.2 | 1.9 |
| | Polyester resin | 0.8 | 0.5 | 0.8 | 0.5 | 0.8 | 0.5 | 0.8 | 0.5 |
| Crosslinking | Melamine resin | 5.5 | 4.4 | 5.5 | 4.4 | 5.5 | 4.4 | 5.5 | 4.4 |
| Agent | | | | | | | | | |
| Cosolvent | Ethylene glycol | 0.0 | | 1.0 | | 2.0 | | 3.0 | |
| Neutralizing | Diethylethanolamine | 1.1 | | 1.1 | | 1.1 | | 1.1 | |
| agent | | | | | | | | | |
| Deionized | | 41.6 | | 41.6 | | 41.6 | | 41.6 | |
| water | | | | | | | | | |
| Aluminum | EMR 4670 | 9.7 | 5.4 | 9.7 | 5.4 | 9.7 | 5.4 | 9.7 | 5.4 |
| Flake | | | | | | | | | |
| Pigment | | | | | | | | | |
| Total | | 100 | | 101 | | 102 | | 103 | |

TABLE 6

| | | S-12* | S-13 | S-14 | S-15* |
|---|---|---|---|---|---|
| Wet film | Solid content (%) | 18.4% | 18.4% | 18.3% | 18.3% |
| properties | pH value | 8.2 | 8.2 | 8.2 | 8.2 |
| | η (A) | 60 | 60 | 60 | 60 |
| | η (B) | 1896 | 1821 | 1757 | 1645 |
| | Ti (η(A)/η(B)) | 31.6 | 30.3 | 29.3 | 27.4 |
| | VOC (water in), g/L | 118 | 121 | 133 | 157 |
| | VOC (water out), g/L | 278 | 315 | 407 | 446 |
| Dry film | Film thickness, μm | 7 | 7 | 7 | 7 |
| properties | Clearcoat film | 45 | 45 | 45 | 45 |
| | thickness, μm | | | | |
| | Primer film | 15 | 15 | 15 | 15 |
| | thickness, μm | | | | |
| Color | Brightness index | 0.17 | 0.2 | 0.32 | 0.34 |
| performance | G* | 4.8 | 4.8 | 3 | 3 |

### 3. Preparation and Evaluation of Waterborne Coating Compositions (Silky Pearl White)

A series of waterborne coating compositions (Silky Pearl White) M-1 to M-9 were prepared according to the components and amounts provided in Table 7 and Table 8, wherein pH of each obtained waterborne coating composition was adjusted to 8.2. Pigment dispersion paste was prepared by mixing pearl white flake pigments with some binder resin. CNF Solution was prepared as the same as Section 1 of the Working Examples.

The obtained waterborne coating compositions were applied as a basecoat. Solid content, viscosity and VOC value of these compositions were determined. The measurement results were shown in Table 8.

### 4. Production and Evaluation of Multilayer Coating Films (Silky Pearl White)

Steel panels coated with a standard cathodic electrocoat material (CathoGuard® 800 gray from BASF Coatings) were employed. Using an ESTA bell (EcoBell III, from Dürr Systems AG, Germany), the primer coating material 1 (N-3000 N8.9, from BASF Coatings GmbH) was applied to the panels and the material 1 was flashed off at room temperature for 5 minutes to form the primer 1 film. Using the same ESTA bell, the primer coating material 2 (N-3000 QAB-CB, from BASF Coatings GmbH) was applied to the primer 1 film and the material 2 was flashed off at room temperature for 5 minutes to form the primer 2 film.

Afterwards, the waterborne coating composition (Silky Pearl White) was applied by means of a rotary atomizer (EcoBell II, from Dürr Systems AG, Germany) (outflow rate of 380 mL/min, rotational speed: 40,000 rpm, voltage: 60 kv) at a temperature of 23° C. and a humidity of 65% so as to provide a dry film thickness of 10 μm. Following the painting, the panels were left at room temperature for 5 minutes and then flashed off at 70° C. for 5 minutes. After cooling to 23° C., a clearcoat paint (ProGloss®, from BASF Coatings GmbH) was applied so as to provide a dry film thickness of 45 μm. Following the painting, the panels were left for 10 minutes and then baked horizontally at 140° C. for 30 minutes, to obtain the final panels with multilayer coating films.

The produced multilayer coating films were evaluated for color performance in terms of brightness index and graininess. The measurement results were summarized in Table 9 and Table 10.

TABLE 7

| | | M-1* | | M-2* | | M-3 | | M-4 | | M-5* | |
|---|---|---|---|---|---|---|---|---|---|---|---|
| | | | Solid | | Solid | | Solid | | Solid | | Solid |
| Components | | Mass | Mass | Mass | Mass | Mass | Mass | Mass | Mass | Mass | Mass |
| Rheology | Type A Rheovis AS | 1.4 | 0.04 | 1.4 | 0.04 | 1.4 | 0.04 | 1.4 | 0.04 | 1.4 | 0.04 |
| Control | 1130 (ASE) | | | | | | | | | | |
| Agent | Type B CNF solution | 20.8 | 0.63 | | | 20.8 | 0.63 | 20.8 | 0.63 | 20.8 | 0.63 |
| | (3%) | | | | | | | | | | |
| Ultraviolet | Tinuvin 123 | 0.6 | 0.6 | 0.6 | 0.6 | 0.6 | 0.6 | 0.6 | 0.6 | 0.6 | 0.6 |
| Absorber | | | | | | | | | | | |
| Dispersion | Dispex Ultra FA 4437 | 0.5 | 0.5 | 0.5 | 0.5 | 0.5 | 0.5 | 0.5 | 0.5 | 0.5 | 0.5 |
| Additive | | | | | | | | | | | |
| Surface | Surfynol 104e | 2.0 | 1 | 0.4 | 0.2 | 0.4 | 0.2 | 0.4 | 0.2 | 0.4 | 0.2 |
| Modifier | | | | | | | | | | | |
| Binder | Polyurethane | 13.9 | 4.5 | 13.9 | 4.5 | 13.9 | 4.5 | 13.9 | 4.5 | 13.9 | 4.5 |
| | PolyAcrilic | 4.2 | 1.9 | 4.2 | 1.9 | 4.2 | 1.9 | 4.2 | 1.9 | 4.2 | 1.9 |
| | Polyester | 0.8 | 0.5 | 0.8 | 0.5 | 0.8 | 0.5 | 0.8 | 0.5 | 0.8 | 0.5 |
| Crosslinking | Melamine resin | 5.5 | 4.4 | 5.5 | 4.4 | 5.5 | 4.4 | 5.5 | 4.4 | 5.5 | 4.4 |
| Agent | | | | | | | | | | | |
| Cosolvent | Polypropylenglycol | 0.0 | | 1.0 | 1 | 1.0 | 1 | 0.0 | | 0.0 | |
| | Butyl glycol | 0.0 | | 0.0 | | 0.0 | | 2.0 | | 3.0 | |
| | Butyldiglycol | 0.0 | | 0.0 | | 0.0 | | 0.0 | | 0.0 | |
| Neutralizing | Diethylethanolamine | 1.1 | | 1.1 | | 1.1 | | 1.1 | | 1.1 | |
| agent | | | | | | | | | | | |
| Deionized | | 35.0 | | 40.0 | | 40.0 | | 40.0 | | 40.0 | |
| Water | | | | | | | | | | | |
| Pearl White | Xirallic T60-10 | 0.3 | 0.3 | 0.3 | 0.3 | 0.3 | 0.3 | 0.3 | 0.3 | 0.3 | 0.3 |
| Flake Pigment | Xirallic T61-10 | 2.5 | 2.5 | 2.5 | 2.5 | 2.5 | 2.5 | 2.5 | 2.5 | 2.5 | 2.5 |
| Total | | 88.6 | | 72.2 | | 93 | | 94 | | 95 | |

TABLE 8

| | | M-6 | | M-7 | | M-8* | | M-9* | |
|---|---|---|---|---|---|---|---|---|---|
| | | | Solid | | Solid | | Solid | | Solid |
| Components | | Mass | Mass | Mass | Mass | Mass | Mass | Mass | Mass |
| Rheology | Type A Rheovis AS | 1.4 | 0.04 | 1.4 | 0.04 | 1.4 | 0.04 | 1.4 | 0.04 |
| Control | 1130 (ASE) | | | | | | | | |
| Agent | Type B CNF solution | 20.8 | 0.63 | 20.8 | 0.63 | 20.8 | 0.63 | 20.8 | 0.63 |
| | (3%) | | | | | | | | |
| Ultraviolet | Tinuvin 123 | 0.6 | 0.6 | 0.6 | 0.6 | 0.6 | 0.6 | 0.6 | 0.6 |
| Absorber | | | | | | | | | |
| Dispersion | Dispex Ultra FA 4437 | 0.5 | 0.5 | 0.5 | 0.5 | 0.5 | 0.5 | 0.5 | 0.5 |
| Additive | | | | | | | | | |
| Surface | Surfynol 104e | 0.4 | 0.2 | 0.4 | 0.2 | 0.4 | 0.2 | 0.4 | 0.2 |
| Modifier | | | | | | | | | |
| Binder | Polyurethane | 13.9 | 4.5 | 13.9 | 4.5 | 13.9 | 4.5 | 13.9 | 4.5 |
| | PolyAcrilic | 4.2 | 1.9 | 4.2 | 1.9 | 4.2 | 1.9 | 4.2 | 1.9 |
| | Polyester | 0.8 | 0.5 | 0.8 | 0.5 | 0.8 | 0.5 | 0.8 | 0.5 |
| Crosslinking | Melamine resin | 5.5 | 4.4 | 5.5 | 4.4 | 5.5 | 4.4 | 5.5 | 4.4 |
| Agent | | | | | | | | | |
| Cosolvent | Butyldiglycol | 2.0 | | 0.0 | | 0.0 | | 0.0 | |
| | Ethylene glycol | 0.0 | | 2.0 | | 0.0 | | 0.0 | |
| | Ethyl Hexanol | 0.0 | | 0.0 | | 2.0 | | 0.0 | |
| | Texanol | 0.0 | | 0.0 | | 0.0 | | 2.0 | |
| Neutralizing | Diethylethanolamine | 1.1 | | 1.1 | | 1.1 | | 1.1 | |
| agent | | | | | | | | | |
| Deionized | | 40.0 | | 40.0 | | 40.0 | | 40.0 | |
| Water | | | | | | | | | |
| Pearl White | Xirallic T60-10 | 0.3 | 0.3 | 0.3 | 0.3 | 0.3 | 0.3 | 0.3 | 0.3 |
| Flake Pigment | Xirallic T61-10 | 2.5 | 2.5 | 2.5 | 2.5 | 2.5 | 2.5 | 2.5 | 2.5 |
| Total | | 94 | | 94 | | 94 | | 94 | |

TABLE 9

| | | M-1* | M-2* | M-3 | M-4 | M-5* |
|---|---|---|---|---|---|---|
| Wet film | Solid content(%) | 19.7% | 23.0% | 18.6% | 17.3% | 17.3% |
| properties | pH value | 8.2 | 8.2 | 8.2 | 8.2 | 8.2 |
| | η(A) | 110 | 90 | 110 | 110 | 110 |
| | η(B) | 3609 | 7760 | 3557 | 3860 | 4009 |
| | Ti (η(A)/ η(B)) | 32.8 | 86.2 | 32.3 | 35.1 | 36.4 |
| | VOC(water in), g/L | 105 | 92 | 87 | 127 | 138 |
| | VOC(water out), g/L | 325 | 325 | 313 | 398 | 427 |
| Dry film | Film thickness, μm | 10 | 10 | 10 | 10 | 10 |
| properties | Clearcoat film thickness, μm | 45 | 45 | 45 | 45 | 45 |
| | Primer 2 film thickness, μm | 12 | 12 | 12 | 12 | 12 |
| | Primer 1 film thickness, μm | 15 | 15 | 15 | 15 | 15 |
| Color | Brightness index | 0.18 | 0.15 | 0.22 | 0.24 | 0.25 |
| performance | G* | 3.5 | 3.6 | 3.4 | 3.4 | 3.4 |

TABLE 10

| | | M-6 | M-7 | M-8* | M-9* |
|---|---|---|---|---|---|
| Wet film | Solid content (%) | 17.3% | 17.3% | 17.3% | 17.3% |
| properties | pH value | 8.2 | 8.2 | 8.2 | 8.2 |
| | η (A) | 110 | 110 | 1101 | 110 |
| | η (B) | 3764 | 2734 | 5119 | 5756 |
| | Ti (η(A)/η(B)) | 34.2 | 24.3 | 47 | 52 |
| | VOC (water in), g/L | 127 | 127 | 127 | 127 |
| | VOC (water out), g/L | 398 | 398 | 3981 | 398 |
| Dry film | Film thickness, μm | 10 | 10 | 10 | 10 |
| properties | Clearcoat film | 45 | 45 | 45 | 45 |
| | thickness, μm | | | | |
| | Primer 2 film | 12 | 12 | 12 | 12 |
| | thickness, μm | | | | |
| | Primer 1 film | 15 | 15 | 15 | 15 |
| | thickness, μm | | | | |
| Color | Brightness index | 0.23 | 0.26 | 0.17 | 0.15 |
| performance | G* | 3.4 | 3.4 | 3.5 | 3.5 |

*Comparative Example

Based on the above experimental results, it can be concluded that examples meeting the requirements of the disclosure had low VOC value and excellent color performance, no matter for aluminum sheet or mica effect pigments. In addition, examples of the disclosure also allowed high solid contents of greater than 15% by weight based on the total weight of the waterborne coating compositions and should realize high material transfer efficiency in application.

1. A waterborne coating composition comprising:
a) a water-soluble or water-dispersible binder;
b) a cellulose nanofiber;
c) a cosolvent of the formula (I) 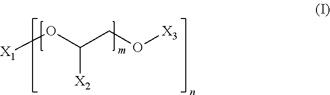
wherein
the combination of X₁ and n is (X₁, n)=(H, 1) or (CH₂—CH—CH₂, 3), X₂ and X₃ are independently selected from the group consisting of hydrogen and alkyl having 1 to 8 carbon atoms, and m is an integer of 1 to 30; and
d) an effect pigment;
wherein
the waterborne coating composition has a volatile organic content of less than or equal to 420 g/l without water, and
a multilayer coating film comprising a basecoat layer obtained by application of the waterborne coating composition and a clearcoat layer on the basecoat layer has a brightness index of greater than or equal to 0.20, wherein the brightness) index=(L*_{15°}−L*_{25°}/L*_{15°}, L*_{15°} and L*_{25°} respectively represent lightness values measured at viewing angles of 15° and 25° according to the L*a*b* color system (CIE lab).

2. The waterborne coating composition according to claim 1, wherein the composition further comprises e) a crosslinking agent.

3. The waterborne coating composition according to claim 1, wherein the water-soluble or water-dispersible binder (a) comprises at least one resin selected from the group consisting of acrylic resin, polyurethane resin, acrylic-urethane resin, polyester resin, polyether resin, alkyd resin, polycarbonate resin and epoxy resin.

4. The waterborne coating composition according to claim 1, wherein the cosolvent (c) has a boiling point of at least 140° C. and has an HLB value of at least 9.

5. The waterborne coating composition according to claim 1, wherein the effect pigment (d) comprises at least one selected from the group consisting of non-vapor-deposited metallic pigment and mica.

6. The waterborne coating composition according to claim 1, wherein the effect pigment (d) has a particle size of 5 to 25 μm.

7. The waterborne coating composition according to claim 1,
wherein the crosslinking agent (e) comprises at least one selected from the group consisting of melamine resin and blocked polyisocyanate.

8. The waterborne coating composition according to claim 1, wherein an effective content of the cellulose nanofiber (b) is from 0.35 wt. % to 0.80 wt. %, based on the total weight of the waterborne coating composition.

9. The waterborne coating composition according to claim 1, wherein a ratio by weight of the cosolvent (c) to the effective content of the cellulose nanofiber (b) is from 1:1 to 6:1.

10. The waterborne coating composition according to claim 1, wherein a weight percentage of the cosolvent (c) is from 70.0 wt. % to 100.0 wt. %, based on total free organic solvents in the waterborne coating composition.

11. The waterborne coating composition according to claim 1, wherein the waterborne coating composition has a solid content of greater than 15 wt. %.

12. The waterborne coating composition according to claim 1, wherein the waterborne coating composition has a volatile organic content of less than or equal to 150 g/l (water in).

13. The waterborne coating composition according to claim 1, wherein the waterborne coating composition has a thixotropy value (Ti value) of less than or equal to 40, wherein the Ti value=η(A)/η(B), η(A) is viscosity under a shearing rate of 1000 s⁻¹ and η(B) is viscosity under a shearing rate of 1 s⁻¹, measured using a rotational viscometer at 23° C.

14. The waterborne coating composition according to claim 1, wherein the multilayer coating film has a graininess Gdiff (G*) of less than or equal to 4.

15. A coating film obtained from the waterborne coating composition according to claim 1, wherein a dry film thickness of the coating film is greater than 5 μm.

16. A coated article comprising a cured coating film on an object, the cured coating film being obtained by curing the waterborne coating composition according to claim 1.

17. A method for producing a multilayer coating film, comprising:
(1) optionally producing a cured first coating layer on the substrate by application of a coating material to the substrate and subsequent curing of the composition;
(2) producing one or more basecoat layers on the coating layer obtained in step (1) by application of one or more identical or different aqueous basecoat materials;
(3) producing one or more clearcoat layers on the one or the topmost basecoat layer by application of one or more identical or different clearcoat materials;
and (4) jointly curing the one or more basecoat layers and the one or more clearcoat layers;
wherein
at least one of the basecoat materials is the waterborne coating composition according to claim 1.

18. A multilayer coating film obtained by the method according to claim 17.

19. The multilayer coating film according to claim 18, wherein the multilayer coating film has a brightness index of greater than or equal to 0.20, wherein the brightness index=(L*_{15°}−L*_{25°})/L*_{15°}, L*_{15°} and L*_{25°} respectively represent lightness values measured at viewing angles of 15° and 25° according to the L*a*b* color system (CIE lab), and a graininess Gdiff (G*) of less than or equal to 4.

20. A method of using the waterborne coating composition according to claim 1, the method comprising using the waterborne coating composition for the production of the pigmented aqueous coating materials.
